(19) United States
(12) Patent Application Publication
(10) Pub. No.: US 2025/0035821 A1
(43) Pub. Date: Jan. 30, 2025

(54) Screen protection film

(71) Applicant: Dongguan Yulong Optoelectronics Co., Ltd, Dongguan (CN)

(72) Inventors: Longnan Piao, Dongguan (CN); Baorui Tan, Dongguan (CN)

(21) Appl. No.: 18/915,386

(22) Filed: Oct. 15, 2024

(30) Foreign Application Priority Data
Jul. 9, 2024 (CN) 2024216171860
Jul. 18, 2024 (CN) 2024217169209

(51) Int. Cl. G02B 1/14; G02B 1/04; G02B 1/111

(52) U.S. Cl. CPC G02B 1/14; G02B 1/04; G02B 1/111

(57) ABSTRACT

This invention discloses a screen protection film, which includes a film body, where one side of the film body is connected to an anti-Newton ring layer through OCA optically clear adhesive layer. One side of the anti-Newton ring layer, which is far from the film body, is provided with at least one foam absorption material layer near the edge through a double-sided adhesive layer. This foam absorption material layer is used to connect with the non-display area at the edge of the electronic device's screen. The screen protection film of the invention can be stably fixed on the screen, effectively reduce the reflectivity of the screen, improve the visibility of the content displayed on the screen, and allowing for repeated installation and removal, making it convenient to use and easy to clean the protective film on a daily basis.

### TECHNICAL FIELD

This invention relates to the technical field of protective films, and more specifically, to a screen protection film.

### BACKGROUND TECHNOLOGY

A screen, also known as a display, is a device or appliance used to display images and colors. It conveys information by displaying text, images, and colors, making it an indispensable visual medium in modern life. With the advancement of technology, screens have been widely used in mobile phones, computers, automobile console, televisions, and devices with image or text display functions.

For instance, the automobile console is an important area in a car used to control air conditioning, audio, and other comfort and entertainment devices. To make the display of images, text, and other information more intuitive and to make it easier for users to operate, automobile console is generally equipped with screens. Especially for automobile console with touchscreens, they can effectively enhance the user's control experience. However, these screens are prone to scratches, which can lead to visible damage. To avoid scratches on the console screen, users typically apply a protective film over the console's large screen. However, existing protective films for automobile console screens have issues such as difficult installation and low visibility of the content displayed on the screen under strong light, which can pose safety risks and affect the user experience.

Similar issues are present on screens of other devices, such as tablets, laptops, and monitors. These screens are prone to scratches during daily use, and when used outdoors or in strong light, the visibility of the content displayed on the screen significantly decreases, making it difficult to recognize the content clearly. Therefore, it is particularly important to design a protective film for screens that can effectively prevent scratches, enhance screen readability, and reduce glare.

### SUMMARY OF THE INVENTION

Based on this, the purpose of this invention is to provide a screen protection film that is used for protecting the screens of in-car central control units and other electronic devices. The screen protection film of the invention can be stably fixed on the screen, effectively reduce the reflectivity of the screen, improve the visibility of the content displayed on the screen, and allowing for repeated installation and removal, making it convenient to use and easy to clean the protective film on a daily basis.

The purpose of this invention is achieved through the following technical solution:

A screen protection film comprising a film body, where one side of the film body is connected to an anti-Newton ring layer through OCA optically clear adhesive layer. One side of the anti-Newton ring layer, which is far from the film body, is provided with at least one foam absorption material layer near the edge through a double-sided adhesive layer. This foam absorption material layer is used to connect with the non-display area at the edge of the electronic device's screen.

The thickness of the OCA optically clear adhesive layer is 3 μm to 50 μm.

Furthermore, the OCA optically clear adhesive layer is a structural layer formed by coating OCA optically clear adhesive with added melanin.

The melanin is carbon black or graphene.

The thickness of the anti-Newton ring layer is 3 μm to 5 μm.

The double-sided adhesive layer includes a PET substrate layer, a silicone adhesive layer on one side of the PET substrate layer, and an acrylic adhesive layer on the other side of the PET substrate layer. The silicone adhesive layer is connected to the anti-Newton ring layer, and the acrylic adhesive layer is connected to the foam absorption material layer on the side away from the PET substrate layer.

Furthermore, The thickness of the PET substrate layer is 30 μm to 100 μm, the thickness of the silicone adhesive layer is 5 μm to 30 μm, and the thickness of the acrylic adhesive layer is 10 μm to 50 μm.

The foam absorption material layer is a structural layer made of acrylic foam material, with a thickness of 100 μm to 200 μm.

Furthermore, The foam absorption material layer is positioned either at one edge, at symmetrical edges, or at all edges of the anti-Newton ring layer through a double-sided adhesive layer.

The film body is one of a paper-like film, a matte film, an anti-radiation film, a privacy film, an anti-reflection film, or an anti-glare anti-reflection film. The thickness of the film body (10) is between 50 μm and 125 μm.

The beneficial effects of the invention are:
1. The use of the OCA optically clear adhesive layer provides high light transmittance, effectively avoiding any impact on the light transmission of the film body itself, and ensuring the overall light transmittance of the invention. When the invention is applied to a screen, the visibility of the screen can be guaranteed. Additionally, combined with the inherent properties of the film body, such as anti-glare, anti-reflection, or reflection reduction functions, the invention effectively reduces glare problems under strong light conditions, thereby improving the visibility of the content displayed on the screen.
2. By adding melanin to the OCA optically clear adhesive optical adhesive, the OCA optically clear adhesive layer formed has the characteristic of absorbing visible light, which further reduces the reflectivity of the invention. When applied to screens, it significantly enhances screen visibility, allowing the content displayed on the screen to be more clearly visible to the user, thus improving the readability of the displayed content and enhancing safety during use.
3. The anti-Newton ring layer consists of an AG (anti-glare) coating material with a slight haze, effectively preventing the Newton ring phenomenon when the film contacts the screen. This improves the quality and appearance of the display when the protective film is applied.
4. The foam absorption material layer is made of acrylic foam material with a microporous structure. During use, it can create a suction cup-like effect on the screen, allowing the invention to be stably fixed to the screen. Additionally, this foam absorption material layer (44) is a non-adhesive structure, which, after being installed on the screen, can be easily removed, allowing for repeated installation and removal on the screen, making it convenient to operate. Moreover, the foam absorption material layer can be washed with water, further facilitating the daily cleaning of the invention.

### BRIEF DESCRIPTION OF THE FIGURES

FIG. 1 is a schematic diagram of the structure of the screen protection film of the invention.

FIG. 2 is a cross-sectional schematic diagram of the structure of the screen protection film of the invention.

FIG. 3 is a schematic diagram of the structure of the double-sided adhesive layer in the screen protection film of the invention.

### REFERENCE NUMERALS

10—Film body; 20—OCA optically clear adhesive layer; 30—Anti-Newton ring layer; 40—Double-sided adhesive layer; 41—PET substrate layer; 42—Silicone adhesive layer; 43—Acrylic adhesive layer; 44—Foam absorption material layer;

### DETAILED DESCRIPTION OF THE EMBODIMENTS

The technical solutions in the embodiments of the invention will be clearly and completely described below in conjunction with the accompanying drawings of the embodiments. It is evident that the described embodiments are merely a portion of the embodiments of the invention, not all of them. All other embodiments obtained by those skilled in the art based on the embodiments in the invention, without making any creative effort, are within the scope of protection of the invention.

In the description of the invention, it should be noted that the terms such as “vertical direction”, “up”, “down”, “horizontal”, and the like are indicative of the direction or positional relationship based on the direction or positional relationship shown in the drawings. They are merely for convenience in describing the invention and simplifying the description and are not intended to indicate or imply that the devices or elements referred to must have a specific orientation or be constructed and operated in a specific orientation. Therefore, these terms should not be construed as limiting the invention. Additionally, “first”, “second”, “third”, and “fourth” are only used for descriptive purposes and should not be understood as indicating or implying relative importance.

In the description of the invention, it should also be noted that unless otherwise expressly stated or limited, the terms “set”, “install”, “link”, and “connect” should be interpreted in a broad sense. For example, it may be a fixed connection, a detachable connection, or an integral connection; it may be a mechanical connection or an electrical connection; it may be a direct connection or an indirect connection through an intermediary; it may be an internal connection between two elements. For those skilled in the art, the specific meanings of the above terms in the invention can be understood in specific situations.

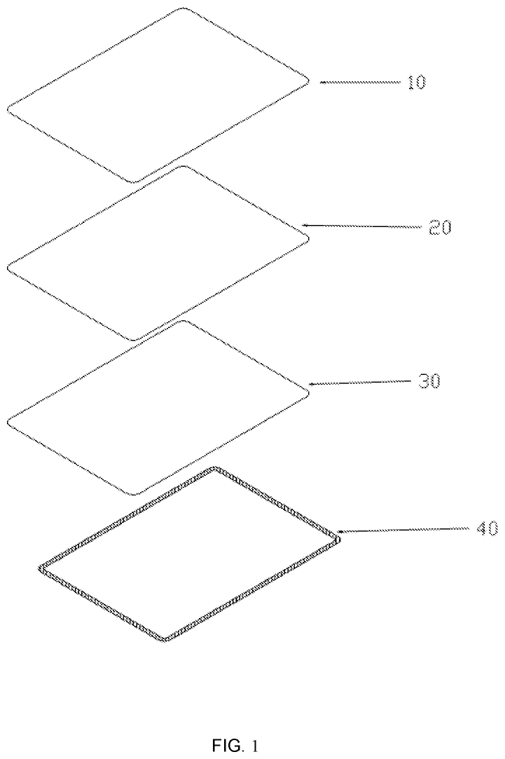

As shown in FIGS. 1-3, the invention relates to a screen protection film comprising a film body (10), where one side of the film body (10) is connected to an anti-Newton ring layer (30) through OCA optically clear adhesive layer (20). One side of the anti-Newton ring layer (30), which is far from the film body (10), is provided with at least one foam absorption material layer (44) near the edge through a double-sided adhesive layer (40). This foam absorption material layer (44) is used to connect with the non-display area at the edge of the electronic device's screen.

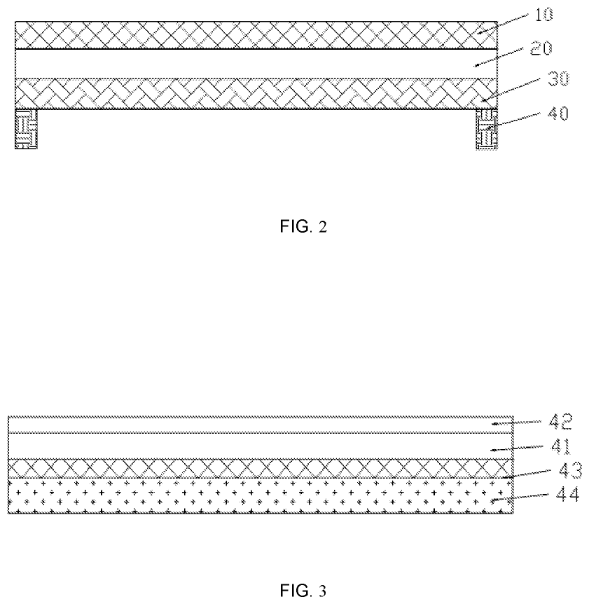

As shown in FIGS. 1-2, the film body (10) is one of a paper-like film, a matte film, an anti-radiation film, a privacy film, an anti-reflection film, or an anti-glare anti-reflection film. The thickness of the film body (10) is between 50 μm and 125 μm. Preferably, the film body (10) is an anti-glare anti-reflection film or an anti-reflection film. In this embodiment, the thickness of the film body (10) is 100 μm. It should be noted that the specific type of the film body (10) can be selected based on the functional characteristics required by the product and is not limited to the examples mentioned here.

As shown in FIGS. 1-2, the thickness of the OCA optically clear adhesive layer optical adhesive layer (20) is between 3 μm and 50 μm, and the adhesive strength of the OCA optically clear adhesive layer (20) is between 800 gf/25 mm and 2000 gf/25 mm. Preferably, the thickness of the OCA optically clear adhesive layer (20) is 10 μm, and its adhesive strength is 1000 gf/25 mm. It should be noted that the OCA optically clear adhesive layer (20) has high light transmittance. Using the OCA optically clear adhesive layer (20) in the invention can effectively avoid affecting the light transmittance of the film body (10) itself, ensuring the overall light transmittance of the invention. When applied to a screen, it ensures screen visibility. Additionally, combined with the inherent anti-glare, anti-reflective, or reflection reduction properties of the film body (10), it effectively reduces glare problems under strong light conditions, thereby enhancing the visibility of the content displayed on the screen.

Furthermore, the OCA optically clear adhesive layer (20) is a structural layer formed by coating OCA optically clear adhesive with added melanin. Specifically, the OCA optically clear adhesive layer (20) is made by coating optical adhesive with 0.013% added melanin. The melanin is preferably carbon black or graphene. By adding melanin to the OCA optically clear adhesive, the coated OCA optically clear adhesive layer (20) acquires the characteristic of absorbing visible light, thereby further reducing the reflectivity of the invention. When applied to screens, this significantly enhances screen visibility, allowing the content displayed to be more clearly visible to the user.

As shown in FIGS. 1-2, the thickness of the anti-Newton ring layer (30) ranges from 3 μm to 5 μm. This anti-Newton ring layer (30) is composed of AG coating material with a slight haze, which can prevent the Newton ring phenomenon when the invention comes into contact with the screen. In this embodiment, the thickness of the anti-Newton ring layer (30) is 4 μm.

As shown in FIG. 3, the double-sided adhesive layer (40) includes a PET substrate layer (41), a silicone adhesive layer (42) on one side of the PET substrate layer (41), and an acrylic adhesive layer (43) on the other side of the PET substrate layer (41). The silicone adhesive layer (42) is connected to the anti-Newton ring layer (30), and the acrylic adhesive layer (43), which is on the side away from the PET substrate layer (41), is connected to the foam absorption material layer (44). The adhesive strength of the silicone adhesive layer (42) is between 10 gf/25 mm and 40 gf/25 mm, and the adhesive strength of the acrylic adhesive layer (43) is between 800 gf/25 mm and 2000 gf/25 mm.

Furthermore, the thickness of the PET substrate layer (41) is between 30 μm and 100 μm, the thickness of the silicone adhesive layer (42) is between 5 μm and 30 μm, and the thickness of the acrylic adhesive layer (43) is between 10 μm and 50 μm.

As shown in FIG. 3, the foam absorption material layer (44) consists of acrylic foam material and has a thickness ranging from 100 μm to 200 μm. This layer features a microporous structure, which, when the invention is applied to a screen, allows air to be expelled from within the foam layer by pressing on it. This reduces the internal pressure within the foam layer to below the external pressure, creating a suction cup-like effect that firmly attaches the invention to the screen.

This effect is particularly beneficial for screens with plastic frames, where the foam absorption material layer (44), when subjected to external pressure, can conform to and embed itself into the surface of the plastic frame. This further enhances the stability and attachment of the invention to the screen. The foam absorption material layer (44) facilitates a quick and easy installation process, even for larger screens, ensuring that the screen protector can be securely affixed without much effort.

Additionally, since the foam absorption material layer (44) is non-adhesive, the invention can be installed and removed repeatedly, offering convenience for users. The foam layer can also be washed, simplifying the daily cleaning and maintenance of the screen protector, contributing to its long-term usability.

Furthermore, the foam absorption material layer (44) is provided at one and only one edge of the anti-Newton ring layer (30) through a double-sided adhesive layer (40), or at the symmetrical edges of the anti-Newton ring layer (30), or at each edge of the anti-Newton ring layer (30).

During use, simply align the edge of the film body (10) with the edge of the screen, press the foam absorption material layer (44) to expel the air, and the invention can be securely and effectively attached to the screen.

When the invention needs to be removed, simply lift one of the upper corners of the film body (10) and gradually separate the film body (10) along the edge of the screen, allowing the invention to be easily removed from the screen, ensuring easy disassembly. After removing the invention, it can be wiped or washed with water, dried, and then carefully stored in a storage clip for the next use.

The above description only represents the preferred technical solution of the invention, which is described in a specific and detailed manner. However, it should not be understood as a limitation on the scope of the patent. It should be noted that for those skilled in the art, various modifications and improvements can be made without departing from the spirit of the invention, and such changes and modifications are intended to be included within the scope of the invention.

1. A screen protection film, comprising a film body, characterized in that: One side of the film body is connected to an anti-Newton ring layer through OCA optically clear adhesive layer. One side of the anti-Newton ring layer, which is far from the film body, is provided with at least one foam absorption material layer near the edge through a double-sided adhesive layer. This foam absorption material layer is used to connect with the non-display area at the edge of the electronic device's screen.

2. The screen protection film according to claim 1, which is characterized in: The thickness of the OCA optically clear adhesive layer is 3 μm to 50 μm.

3. The screen protection film according to claim 1, which is characterized in: The OCA optically clear adhesive layer is a structural layer formed by coating OCA optically clear adhesive with added melanin.

4. The screen protection film according to claim 3, which is characterized in: The melanin is carbon black or graphene.

5. The screen protection film according to claim 1, which is characterized in: The thickness of the anti-Newton ring layer is 3 μm to 5 μm.

6. The screen protection film according to claim 1, which is characterized in: The double-sided adhesive layer includes a PET substrate layer, a silicone adhesive layer on one side of the PET substrate layer, and an acrylic adhesive layer on the other side of the PET substrate layer. The silicone adhesive layer is connected to the anti-Newton ring layer, and the acrylic adhesive layer is connected to the foam absorption material layer on the side away from the PET substrate layer.

7. The screen protection film according to claim 6, which is characterized in: The thickness of the PET substrate layer is 30 μm to 100 μm, the thickness of the silicone adhesive layer is 5 μm to 30 μm, and the thickness of the acrylic adhesive layer is 10 μm to 50 μm.

8. The screen protection film according to claim 6, which is characterized in: The foam absorption material layer is a structural layer made of acrylic foam material, with a thickness of 100 μm to 200 μm.

9. The screen protection film according to claim 1, which is characterized in: The foam absorption material layer is provided at one and only one edge of the anti-Newton ring layer through a double-sided adhesive layer, or at the symmetrical edges of the anti-Newton ring layer, or at each edge of the anti-Newton ring layer.

10. The screen protection film according to claim 1, which is characterized in: The film body is one of a paper-like film, a matte film, an anti-radiation film, a privacy film, an anti-reflection film, or an anti-glare anti-reflection film. The thickness of the film body (10) is between 50 μm and 125 μm.
